(19) United States
(12) Patent Application Publication
(10) Pub. No.: US 2005/0058806 A1
(43) Pub. Date: Mar. 17, 2005

(54) Folded sheet articles and related methods

(76) Inventors: Mina Hwang, Coral Springs, FL (US); Dan M. De La Rosa, Saddle River, NJ (US)

Correspondence Address: Dan de la Rosa, Suite 274, 345 E 80th St., New York, NY, 10021, US

(21) Appl. No.: 10/663,500

(22) Filed: Sep. 17, 2003

(51) Int. Cl. B32B 3/04

(52) U.S. Cl. 428/121

(57) ABSTRACT

A folded sheet article is provided, the article comprising: a sheet of material having a folded state and an unfolded state; a first fold in the sheet of material; a set of accordion folds in the sheet of material, the set of accordion folds being folded in a direction transverse to the first fold; a second fold in the sheet of material, the second fold being folded in a direction transverse to the set of accordion folds; the first and second folds and the set of accordion folds defining segments of the sheet of material; and a stiff portion attached to a corner segment and a segment adjacent to the corner segment of the sheet formed by the second fold and whereby during the folded state, the segments are situated within the stiff portion.

### BACKGROUND OF THE INVENTION

1. Field of the Invention

The present invention relates to a foldable, unfoldable and refoldable sheet article comprising: a sheet of material having a first fold and a set of accordion folds being folded in a direction transverse to the first fold; a second fold in the sheet of material, the second fold being folded in a direction transverse to the set of accordion folds; the first and second folds and the set of accordion folds defining segments of the sheet of material; the second fold forming a first corner segment and a segment adjacent to the first corner segment; and in a folded state, the first corner segment and the segment adjacent to the first corner segment formed by the second fold functions as a cover for the segments.

More specifically, the present invention relates to a folded sheet article comprising: a sheet of material having a folded state and an unfolded state; a first fold in the sheet of material; a plurality of accordion folds in the sheet of material, the plurality of accordion folds being folded in a direction transverse to the first fold; a second fold in the sheet of material, the second fold being folded in a direction transverse to the first plurality of accordion folds; the first and second folds and the plurality of accordion folds defining segments of the sheet of material; and a stiff portion attached to a corner segment and a segment adjacent to the corner segment of the sheet formed by the second fold and whereby during the folded state, the segments are situated within the stiff portion.

2. Description of the Related Art

The prior art relates to folded sheet articles that have segments that are formed during the folding process and have two stiff portions attached to the opposing segments of the folded sheet; and in a folded state, the folded segments are sandwiched within the two stiff portions of the folded sheet article. These folded sheets contain various instructional sheets, subway and train maps, road maps, amusement park maps, and other long sheets of paper material that can be folded for compactness and travel.

U.S. Pat. No. 5,156,898 to McDonald relates to a formed sheet of material with two sets of concertina folds (accordion folds) folded in opposing directions and two diagonally stiff portions that are larger than the other portions formed by the folds; and in an unfolded format, the stiff portions are located at opposite corners of the sheet and in a folded format, the folded segments are sandwiches within the two stiff portions of the folded sheet article and the stiff portions function as the exterior for the folded segments.

U.S. Pat. No. 6,410,114 to McDonald relates to a sheet material having at least one set of folds and a rotatable disc attached to the sheet and a stiff portion situated at a corner of the sheet material.

U.S. Pat. No. 6,103,332 to McDonald relates to a folded sheet means having a first set of concertina folds and a second set of folds folded in opposing directions and having holding and connection means.

U.S. Pat. No. 6,056,323 to McDonald relates to an apparatus and process for stiffening a portion of the sheet and for folding the sheets into two opposing concertina folds.

U.S. Pat. No. 6,007,895 to McDonald relates to a folded sheet article having a folded non-stiff sheet with two opposing concertina folds with at least one stiff portion with at least part of the stiff portion comprising a transparent material.

U.S. Pat. No. 5,954,195 to McDonald relates to an apparatus and process for producing folded sheets wherein at least one concertina fold is first provided and then at least one stiff portion is attached to an outer segment of the folded sheet.

U.S. Patent No. Re. 36,395 to McDonald relates to a folded sheet article with two sets of concertina folds folded in opposing directions and with two diagonally opposite stiff portions located at diagonally opposite corners of the sheet and the sheet having a pocket.

U.S. Pat. No. 5,358,761 to McDonald relates to a sheet with two concertina folds folded in opposite directions and having two diagonally opposite segments located at opposing corners; one corner having a stiff portion and having holding means for use with a binder.

U.S. Pat. No. 5,351,991 to McDonald relates to a sheet with two concertina folds folded in opposite directions and having at least three panels; having a sealing and opening means; and diagonally opposite segments.

U.S. Pat. No. 5,928,753 to Perttunen et al. relates to a sheet article having two concertina folds folded in opposite directions to form segments and two tabs located on the edges of the corner segments of the sheet.

U.S. Pat. No. 5,882,763 to Perttunen et al. relates to a sheet article with two concertina folds folded in opposing directions and having a first corner segment and a first stiff portion mounted at the first corner segment and a second stiff portion.

The above prior art references relate to folded sheet articles that do not properly cover and protect the folded segments of the folded sheet article, causing numerous durability issues; in fact, during use of the folded sheet articles covered by the above prior art references, there is constant twisting of the two opposing stiff portions which causes damage to the folded segments and the overall folded sheet article. In addition, the unfolding and refolding of the sheet articles of the prior art requires some practice in terms of its use and becomes very difficult to refold when there is a plurality of folded segments within the two stiff portions.

The present invention relates to a folded sheet article that properly covers and protects the folded segments and the overall folded sheet article. The present invention also provides a more user-friendly product which does not have twisting problems and thus, is more durable and stable during the constant folding, unfolding and refolding process. The present invention provides for a folded sheet article that can make foldable sheets of material such as maps into a compact and portable, pocket-held device.

### SUMMARY OF THE INVENTION

In one embodiment, the present invention provides a folded sheet article comprising: a sheet of material having a folded state and an unfolded state; a first fold in the sheet of material; a set of accordion folds in the sheet of material, the set of accordion folds being folded in a direction transverse to the first fold; a second fold in the sheet of material, the second fold being folded in a direction transverse to the set of accordion folds; the first and second folds and the set of accordion folds defining segments of the sheet of material; and a stiff portion attached to a corner segment and a segment adjacent to the corner segment of the sheet formed by the second fold and whereby during the folded state, the segments are situated within the stiff portion.

In another embodiment, the first fold comprises a one-third fold in the sheet of material. In still another embodiment, the first fold comprises a one-half fold in the sheet of material. In yet another embodiment, the set of accordion folds comprises at least four folds.

In still yet another embodiment, the stiff portion comprises a one-piece foldable material. In a further embodiment, the stiff portion comprises at least two separate pieces, a first piece being attached to the corner segment and a second piece being attached to the segment adjacent to the corner segment. In still a further embodiment, the stiff portion is larger than the segments formed by the folds.

In yet a further embodiment, the folded sheet article further comprises at least one tab. In still yet a further embodiment, the tab is a foldable tab. In another further embodiment, the tab is attached to a corner segment opposite of the corner segment where the stiff portion is attached. In still another further embodiment, the stiff portion comprises opposing ends and an extended portion connected to the first end and whereby during the folded state, the extended portion overlaps and can be secured onto the second end of the stiff portion. In yet another further embodiment, the extended portion of said stiff portion comprises a closing means. In still yet another further embodiment, the closing means comprises an adhesive. In another embodiment, the stiff portion comprises a pocket. In yet another embodiment, the article comprises paper.

In still another embodiment, the present invention also relates to a foldable, unfoldable and refoldable sheet article comprises: a sheet of material having a first fold and a set of accordion folds being folded in a direction transverse to the first fold; a second fold in the sheet of material the second fold being folded in a direction transverse to the set of accordion folds; the first and second folds and the set of accordion folds defining segments of the sheet of material; the second fold forming a first corner segment and a segment adjacent to the first corner segment; and in a folded state, the first corner segment and the segment adjacent to the first corner segment formed by the second fold functions as a cover for the segments.

In still yet another embodiment, the sheet article further comprises a first stiff portion attached to the first corner segment and the segment adjacent to the first corner segment of the sheet formed by the second fold and whereby during the folded state, the segments are situated within the first stiff portion. In a further embodiment, the sheet article further comprises a second stiff portion attached to a second corner segment opposite of the first corner segment. In yet a further embodiment, the sheet article further comprises at least one tab attached to the second stiff portion. In still a further embodiment, the tab attached to the second stiff portion is a foldable tab.

In still yet a further embodiment, the first fold comprises a one-third fold in the sheet of material and the first and second folds form at least three vertical segments. In another further embodiment, the first fold comprises a one-half fold in the sheet of material and the first and second folds form at least four vertical segments. In yet another further embodiment, the first set of accordion folds forms at least four horizontal segments.

In still another further embodiment, the sheet article further comprises at least one tab attached at least one segment on the sheet of material. In another embodiment, the first stiff portion comprises opposing ends and an extended portion connected to the first end and whereby during the folded state, the extended portion overlaps and can be secured onto the second end of the first stiff portion. In still another embodiment, the corner segment formed by the second fold comprises a pocket. In yet another embodiment, the stiff portion comprises a pocket.

In still yet another embodiment, the present invention relates to a foldable sheet article manufactured by a method comprising: providing a sheet of material having a folded state and an unfolded state; forming a first fold in the sheet of material; forming a set of accordion folds in the sheet of material, the set of accordion folds being folded in a direction transverse to the first fold; forming a second fold in the sheet of material, the second fold being folded in a direction transverse to the set of accordion folds; the first and second folds and the set of accordion folds defining segments of the sheet of material; and attaching a stiff portion to a corner segment and a segment adjacent to the corner segment of said sheet formed by the second fold and whereby during the folded state, the segments are situated within the stiff portion.

In a further embodiment, the sheet article further comprises attaching at least one tab to at least one segment of the sheet of material. In yet a further embodiment, the stiff portion comprises opposing ends and an extended portion connected to the first end and whereby during the folded state, and allowing the extended portion to overlap and be secured onto the second end of the stiff portion. In still a further embodiment, the sheet article further comprises providing a pocket on the stiff portion.

In still yet a further embodiment, the present invention also relates to a method of manufacturing a folded sheet article, the method comprising: providing a sheet of material having a folded state and an unfolded state; forming a first fold in the sheet of material; forming a plurality of accordion folds in the sheet of material, the plurality of accordion folds being folded in a direction transverse to the first fold; forming a second fold in the sheet of material, the second fold being folded in a direction transverse to the plurality of accordion folds; the first and second folds and the plurality of accordion folds defining segments of the sheet of material; the second fold forming a first corner segment and a segment adjacent to the first corner segment; and in a folded state, the first corner segment and the segment adjacent to the first corner segment formed by the second fold functions as a cover for the segments.

In a further embodiment, the method further comprises attaching a first stiff portion to the first corner segment and the segment adjacent to the first corner segment of the sheet formed by the second fold and whereby during the folded state, the segments are situated within the first stiff portion. In yet a further embodiment, the stiff portion comprises a one-piece foldable material. In still a further embodiment, the stiff portion comprises at least two separate pieces, a first piece being attached to the corner segment and a second piece being attached to the segment adjacent to the corner segment. In still yet a further embodiment, the stiff portion is larger than the segments formed by the folds. In another further embodiment, the method further comprises attaching at least one tab to at least one segment of the sheet of material. In still another further embodiment, the tab is a foldable tab and is attached to a corner segment opposite of the corner segment where the stiff portion is attached.

In yet another further embodiment, the stiff portion comprises opposing ends and an extended portion connected to the first end and whereby during the folded state, and allowing the extended portion to overlap and be secured onto the second end of the stiff portion. In another embodiment, the extended portion of said stiff portion comprises a closing means. In yet another embodiment, the method further comprises providing a pocket on the stiff portion. In still another embodiment, the method further comprises attaching a second stiff portion to a second corner segment opposite of the first corner segment. In still yet another embodiment, the method further comprises at least one tab attached to the second stiff portion.

In a further embodiment, the present invention provides a folded sheet article comprising: a sheet of material having a folded state and an unfolded state; a set of accordion folds in the sheet of material; a fold in the sheet of material, the fold being folded in a direction transverse to the first set of accordion folds; the fold and the set of accordion folds defining segments of the sheet of material; and a first stiff portion attached to a first corner segment and a segment adjacent to the first corner segment of the sheet formed by the fold and whereby during the folded state, the segments are situated within the stiff portion.

In another embodiment, the folded sheet article further comprises a second stiff portion attached to a second corner segment situated opposite of the first corner segment. In yet another embodiment, the second stiff portion comprises a foldable tab. In still another embodiment, the folded sheet article further comprises at least one tab attached to at least one segment of said sheet of material.

In a further embodiment, the present invention provides an apparatus and process for producing folded sheet articles wherein a stiff portion covering a corner segment and a segment adjacent to the corner segment is attached to the sheet and then a non-concertina fold is made followed by a concertina fold in an opposing direction and then finally another non-concertina fold is made in a direction opposite of the concertina fold, and wherein the stiff portion is a part of the last fold and the stiff portion thereby partially covers and protects the folded segments in the folded state.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a perspective of one of the embodiments of the present invention in a folded stage;

FIG. 2 is an overhead view of one of the embodiments of the present invention in a fully unfolded stage;

FIG. 3 is a perspective view of FIG. 2 showing a first fold, which is a one-third fold of the sheet material;

FIG. 4 is a perspective view of FIG. 3 showing the first concertina (accordion) fold, which is folded in a direction opposite of the first fold;

FIG. 5 is a perspective view of FIG. 4 showing a second fold, which is folded in a direction opposite of the first concertina fold;

FIG. 6 is a perspective view of another embodiment of the present invention wherein the sheet material article is provided with a first fold, which is a one-half fold of the sheet material;

FIG. 7 is a perspective view of FIG. 6 showing the first concertina fold, which is folded in a direction opposite of the first fold; and

FIG. 8 is a perspective view of FIG. 7 showing a second fold, which is folded in a direction opposite of the first concertina fold.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

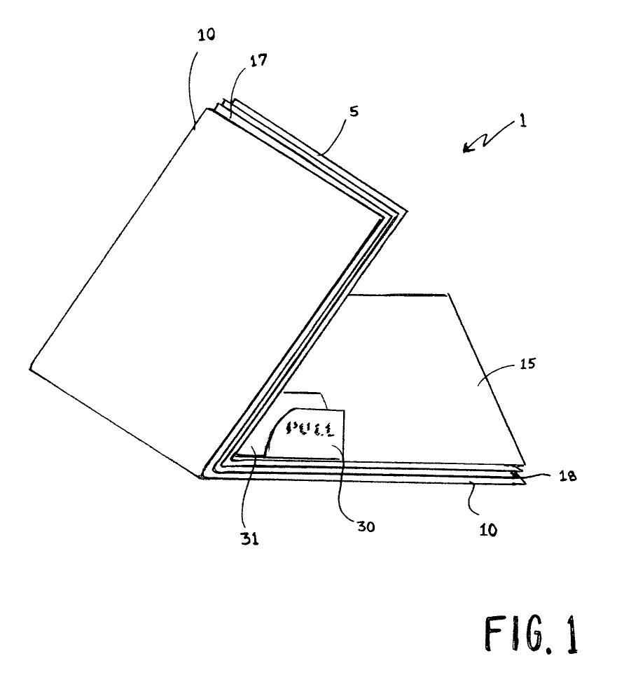

Referring now to the drawings, FIG. 1 relates to a perspective view of one of the embodiments of the folded sheet article 1 the present invention in a folded stage. The folded sheet article 1 comprises a sheet of material 5 having a folded state and an unfolded state; a first fold in the sheet of material 5; a set of accordion folds in the sheet of material 5, the set of accordion folds being folded in a direction transverse to the first fold; a second fold in the sheet of material 5, the second fold being folded in a direction transverse to the set of accordion folds; the first and second folds and the set of accordion folds defining segments 15 of the sheet of material; and a stiff portion 10 attached to a corner segment 17 and a segment 18 adjacent to the corner segment 17 of the sheet formed by the second fold and whereby during the folded state, the segments 15 are situated within the stiff portion 10. The folded sheet article 1 further comprises a second stiff portion 31, which is situated on a corner segment opposite the first corner segment 17 where the first stiff portion 10 is attached. The second stiff portion 31 further comprises a foldable tab 30. To unfold the folded sheet article 1, the user would hold the first stiff portion 10 and then pull tab 30 until all of the folded parts of the paper are unfolded and all of the segments 15 of the folded sheet article 1 is visible by the user.

In another embodiment, the user holds the stiff portion 10 with one hand and the pull tab 30 with the other hand and by pulling the tab 30 and stiff portion 10 in opposing directions with a single motion, the sheet of material 5 can be unfolded. To refold the sheet article, the user pushes the stiff portion 10 toward the tab 30 while allowing the sheet of material to return to the folded state. In a further embodiment, the stiff portion 10 can be constructed of cardboard or thick paper or even plastic (such as a credit card material). The sheet of material 5 can have printed material such as a map and can be of any size including a square or rectangle. The folded sheet article 1 of the present invention can be stored in the user's clothing pockets, wallets, purses, etc.

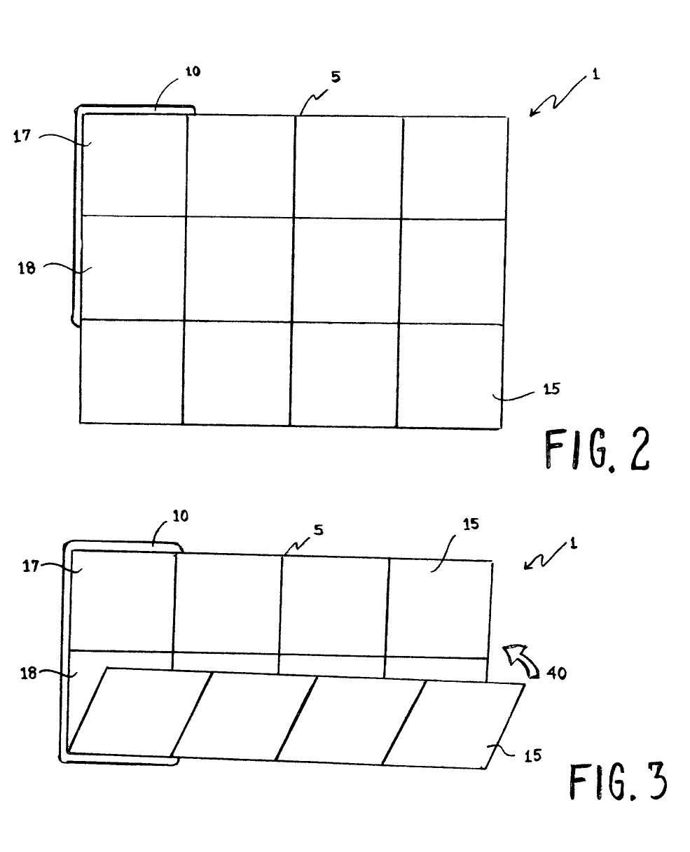

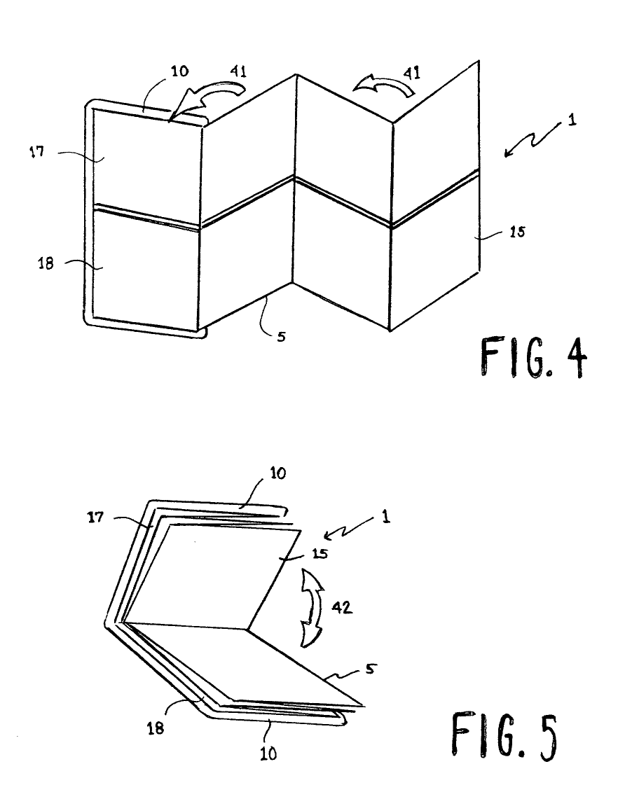

FIG. 2 illustrates the unfolded state of one of the embodiments of the folded sheet article 1 of the present invention. FIGS. 3-5 shows how the folded sheet article 1 of FIG. 2 is taken to a folded state. In one embodiment, the folded sheet article 1 in FIG. 2 comprises twelve (12) foldable segments including three (3) vertical segments and four (4) horizontal segments. The sheet of material 5 is first folded 40 vertically to one-third of the vertical length of the sheet of material 5 as shown in FIG. 3. Then, the sheet of material 5 is provided with a set of accordion folds 41 in a direction opposite of the first fold 40 (in this case, a horizontal accordion fold) as illustrated by FIG. 4. Finally, the sheet of material 5 is given a second fold 42 in a direction opposite of the set of accordion folds 41 (in this case, a vertical second fold) as shown in FIG. 5. In one embodiment, the stiff portion 10 is attached to the corner segment 17 and the segment 18 adjacent to the corner segment 17 and during the second fold 42, the stiff portion 10 is folded in half and functions as a cover for the folded segments 15 and the sheet of material 5 during its folded state.

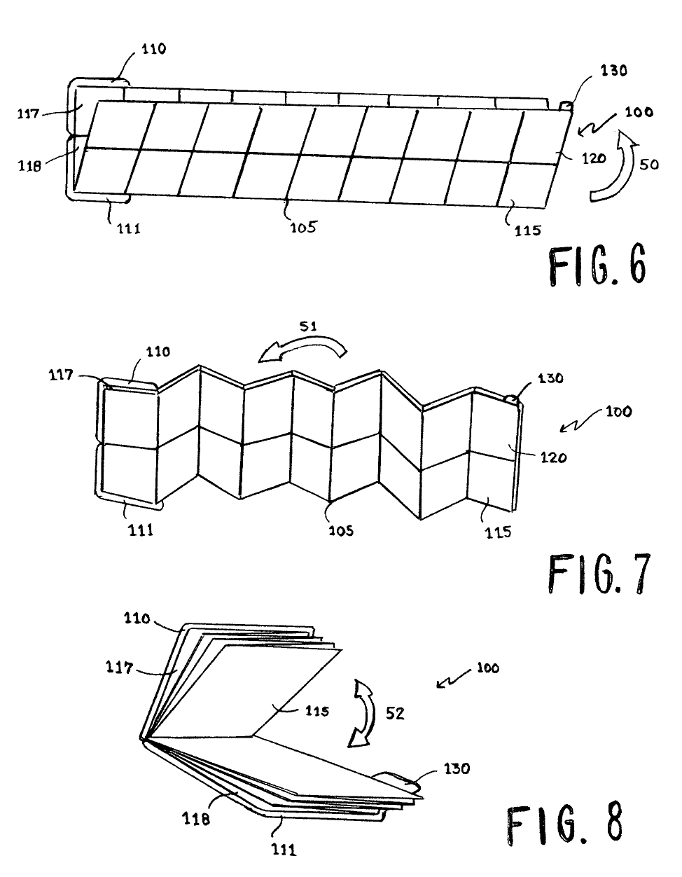

FIGS. 6-8 relates to a folded sheet article 100 comprising a sheet of material 105 taken from an unfolded state to a folded state. The folded sheet article 100 comprises thirty-six (36) foldable segments with four (4) vertical segments and nine (9) horizontal segments. The sheet of material 105 is first folded 50 vertically to one-half of the vertical length of the sheet of material 105 as shown in FIG. 6. Then, the sheet of material 105 is provided with a set of accordion folds 51 in a direction opposite of the first fold 50 (in this case, a horizontal accordion fold) as illustrated by FIG. 7. Finally, the sheet of material 105 is given a second fold 52 in a direction opposite of the set of accordion folds 51 (in this case, a vertical second fold) as shown in FIG. 8.

In another embodiment, the folded sheet article 100 in FIGS. 6-8 comprises at least two stiff portions, 110 and 111 respectively, which are attached to the corner segment 117 and the segment 118 adjacent to the corner segment 117 and the second fold 52 is made between the first and second stiff portions 110 and 111. The stiff portions, 110 and 111 respectively, function as a cover for the folded segments 115 and the sheet of material 105 during its folded state. In addition, the folded sheet article 100 of the present invention comprises a tab 130 attached to a corner segment 120 opposite of corner segment 117. The tab 130 can be foldable within the stiff portions 110 and 111 during the folded state.

Numerous modifications and variations of the present invention are possible in light of the above teachings. It is therefore to be understood that within the scope of the attendant claims attached hereto, this invention may be practiced otherwise than as specifically disclosed herein.

1. A folded sheet article comprising:
a sheet of material having a folded state and an unfolded state;
a first fold in said sheet of material;
one set of accordion folds in said sheet of material, said set of accordion folds being folded in a direction transverse to said first fold;
a second fold in said sheet of material, said second fold being folded in a direction transverse to said first plurality of accordion folds;
said first and second folds and said set of accordion folds defining segments of said sheet of material; and
a stiff portion attached to a corner segment and a segment adjacent to said corner segment of said sheet formed by said second fold and whereby during said folded state, said segments are situated within said stiff portion.

2. The folded sheet article of claim 1 wherein said first fold comprises a one-third fold in said sheet of material.

3. The folded sheet article of claim 1 wherein said first fold comprises a one-half fold in said sheet of material.

4. The folded sheet article in claim 1 wherein said set of accordion folds comprises at least four folds.

5. The folded sheet article of claim 1 wherein said stiff portion comprises a one-piece foldable material.

6. The folded sheet article of claim 1 wherein said stiff portion comprises at least two separate pieces, a first piece being attached to said corner segment and a second piece being attached to said segment adjacent to said corner segment.

7. The folded sheet article of claim 1 wherein said stiff portion is larger than said segments formed by said folds.

8. The folded sheet article of claim 1 further comprises at least one tab.

9. The folded sheet article of claim 8 wherein said tab is a foldable tab.

10. The folded sheet article of claim 8 wherein said tab is attached to a corner segment opposite of said corner segment where said stiff portion is attached.

11. The folded sheet article of claim 1 wherein said stiff portion comprises opposing ends and an extended portion connected to said first end and whereby during said folded state, said extended portion overlaps and can be secured onto said second end of said stiff portion.

12. The folded sheet article of claim 11 wherein said extended portion of said stiff portion comprises a closing means.

13. The folded sheet article of claim 12 wherein said closing means comprises an adhesive.

14. The folded sheet article of claim 1 wherein said stiff portion comprises a pocket.

15. The folded sheet article of claim 1 wherein said article comprises paper.

16. A foldable, unfoldable and refoldable sheet article comprising:
a sheet of material having a first fold and one set of accordion folds being folded in a direction transverse to said first fold;
a second fold in said sheet of material, said second fold being folded in a direction transverse to said set of accordion folds;
said first and second folds and said set of accordion folds defining segments of said sheet of material; said second fold forming a first corner segment and a segment adjacent to said first corner segment; and
in a folded state, said first corner segment and said segment adjacent to said first corner segment formed by said second fold functions as a cover for said segments.

17. The sheet article of claim 16 further comprises a first stiff portion attached to said first corner segment and said segment adjacent to said first corner segment of said sheet formed by said second fold and whereby during said folded state, said segments are situated within said first stiff portion.

18. The sheet article of claim 17 further comprises a second stiff portion attached to a second corner segment opposite of said first corner segment.

19. The sheet article of claim 18 further comprises at least one tab attached to said second stiff portion.

20. The sheet article of claim 19 wherein said tab attached to said second stiff portion is a foldable tab.

21. The sheet article of claim 16 wherein said first fold comprises a one-third fold in said sheet of material and said first and second folds form at least three vertical segments.

22. The sheet article of claim 16 wherein said first fold comprises a one-half fold in said sheet of material and said first and second folds form at least four vertical segments.

23. The sheet article of claim 16 wherein said set of accordion folds forms at least four horizontal segments.

24. The sheet article of claim 16 further comprises at least one tab attached at least one segment on said sheet of material.

25. The sheet article of claim 17 wherein said first stiff portion comprises opposing ends and an extended portion connected to said first end and whereby during said folded state, said extended portion overlaps and can be secured onto said second end of said first stiff portion.

26. The sheet article of claim 16 wherein said corner segment formed by said second fold comprises a pocket.

27. The sheet article of claim 17 wherein said stiff portion comprises a pocket.

28. The sheet article of claim 16 wherein said article comprises paper.

29. A foldable sheet article manufactured by a method comprising:
providing a sheet of material having a folded state and an unfolded state;
forming a first fold in said sheet of material;
forming one set of accordion folds in said sheet of material, said set of accordion folds being folded in a direction transverse to said first fold;
forming a second fold in said sheet of material, said second fold being folded in a direction transverse to said set of accordion folds;
said first and second folds and said set of accordion folds defining segments of said sheet of material; and
attaching a stiff portion to a corner segment and a segment adjacent to said corner segment of said sheet formed by said second fold and whereby during said folded state, said segments are situated within said stiff portion.

30. The sheet article of claim 29 further comprises attaching at least one tab to at least one segment of said sheet of material.

31. The sheet article of claim 29 wherein said stiff portion comprises opposing ends and an extended portion connected to said first end and whereby during said folded state, and allowing said extended portion to overlap and be secured onto said second end of said stiff portion.

32. The sheet article of claim 29 further comprises providing a pocket on said stiff portion.

33. A method of manufacturing a folded sheet article, said method comprising:
providing a sheet of material having a folded state and an unfolded state;
forming a first fold in said sheet of material;
forming a plurality of accordion folds in said sheet of material, said plurality of accordion folds being folded in a direction transverse to said first fold;
forming a second fold in said sheet of material, said second fold being folded in a direction transverse to said first plurality of accordion folds;
said first and second folds and said plurality of accordion folds defining segments of said sheet of material; said second fold forming a first corner segment and a segment adjacent to said first corner segment; and
in a folded state, said first corner segment and said segment adjacent to said first corner segment formed by said second fold functions as a cover for said segments.

34. The method of claim 33 further comprising attaching a first stiff portion to said first corner segment and said segment adjacent to said first corner segment of said sheet formed by said second fold and whereby during said folded state, said segments are situated within said first stiff portion.

35. The method of claim 33 wherein said stiff portion comprises a one-piece foldable material.

36. The method of claim 33 wherein said stiff portion comprises at least two separate pieces, a first piece being attached to said corner segment and a second piece being attached to said segment adjacent to said corner segment.

37. The method of claim 33 wherein said stiff portion is larger than said segments formed by said folds.

38. The method of claim 33 further comprises attaching at least one tab to at least one segment of said sheet of material.

39. The method of claim 38 wherein said tab is a foldable tab and is attached to a corner segment opposite of said corner segment where said stiff portion is attached.

40. The method of claim 33 wherein said stiff portion comprises opposing ends and an extended portion connected to said first end and whereby during said folded state, and allowing said extended portion to overlap and be secured onto said second end of said stiff portion.

41. The method of claim 40 wherein said extended portion of said stiff portion comprises a closing means.

42. The method of claim 33 further comprises providing a pocket on said stiff portion.

43. The method of claim 33 wherein said article comprises paper.

44. The method of claim 34 further comprises attaching a second stiff portion to a second corner segment opposite of said first corner segment.

45. The method of claim 44 further comprises at least one tab attached to said second stiff portion.

46. The method of claim 45 wherein said tab attached to said second stiff portion is a foldable tab.

47. A folded sheet article comprising:
a sheet of material having a folded state and an unfolded state;
one set of accordion folds in said sheet of material;
a fold in said sheet of material, said fold being folded in a direction transverse to said set of accordion folds;
said fold and said set of accordion folds defining segments of said sheet of material; and
a first stiff portion attached to a first corner segment and a segment adjacent to said first corner segment of said sheet formed by said fold and whereby during said folded state, said segments are situated within said stiff portion.

48. The folded sheet article of claim 47 further comprises a second stiff portion attached to a second corner segment situated opposite of said first corner segment.

49. The folded sheet article of claim 48 wherein said second stiff portion comprises a foldable tab.

50. The folded sheet article of claim 47 further comprises at least one tab attached to at least one segment of said sheet of material.
